(19) United States
(12) Patent Application Publication
(10) Pub. No.: US 2023/0362889 A1
(43) Pub. Date: Nov. 9, 2023

(54) ADAPTIVE SUB-GROUPING AND PAGING FOR USER EQUIPMENT

(71) Applicant: QUALCOMM Incorporated, San Diego, CA (US)

(72) Inventors: Huilin XU, Temecula, CA (US); Raghu Narayan CHALLA, San Diego, CA (US); Peng CHENG, Beijing (CN); Yuwei REN, Beijing (CN)

(21) Appl. No.: 18/247,223

(22) PCT Filed: Dec. 16, 2020
(86) PCT No.: PCT/CN2020/136684

§ 371 Date: Mar. 29, 2023

(51) Int. Cl. H04W 68/02; H04W 8/24

(52) U.S. Cl. CPC H04W 68/025; H04W 8/24

(57) ABSTRACT

Some techniques and apparatuses described herein provide sub-grouping of paging groups of user equipment (UEs) based at least in part on one or more parameters associated with a UE, such as a UE type of the UE or a measured channel condition at the UE. A base station may assign the UE to a paging sub-group based at least in part on the information associated with the one or more parameters. In some aspects, the base station may determine paging transmission parameters for the UE based at least in part on the information associated with the one or more parameters, such as a paging early indication (PEI) location, a beam where a PEI and/or a paging message is to be transmitted, a number of repetitions for a paging occasion, or the like.

### FIELD OF THE DISCLOSURE

Aspects of the present disclosure generally relate to wireless communication and to techniques and apparatuses for adaptive sub-grouping and paging for a user equipment (UE).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a 5G BS, a 5G Node B, or the like.

The above multiple access technologies have been adopted in various telecommunication standards to provide a common protocol that enables different wireless communication devices to communicate on a municipal, national, regional, and even global level. 5G, which may also be referred to as New Radio (NR), is a set of enhancements to the LTE mobile standard promulgated by the Third Generation Partnership Project (3GPP). 5G is designed to better support mobile broadband Internet access by improving spectral efficiency, lowering costs, improving services, making use of new spectrum, and better integrating with other open standards using OFDM with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and 5G technologies. Preferably, these improvements should be applicable to other multiple access technologies and the telecommunication standards that employ these technologies.

### SUMMARY

Paging provides a mechanism for power saving at a UE. A UE may monitor a paging occasion for a paging control channel, and may awaken to decode a corresponding paging shared channel only if a paging control channel is received. Thus, the UE reduces power consumption associated with indiscriminately awakening for the shared channel. The paging control channel and the paging shared channel may be transmitted on all synchronization signal block beams of a cell with repetition. Further power savings can be achieved by utilizing a paging early indication (PEI). The PEI can indicate whether a UE should awaken to monitor for the paging control channel, which saves monitoring resources of the UE that would be used to indiscriminately monitor for paging control channels. In a paging configuration, UEs may be grouped, so that a paging control channel is directed to a group of UEs. As used herein, “group of UEs” refers to a set of one or more UEs that are configured to monitor the same paging occasion (e.g., a group of UEs which a network can page on a single paging occasion). UEs can also be sub-grouped, meaning that subsets of UEs (e.g., sub-groups) associated with the same paging occasion can be independently paged. A sub-group of UEs can be associated with a PEI. For example, a PEI directed to a sub-group of UEs may indicate that the sub-group of UEs is to monitor a corresponding paging occasion.

Different types of UEs (e.g., Internet of Things (IoT) UEs, machine-type communication (MTC) UEs, Reduced Capability (RedCap) UEs, eMBB UEs, and so on) may be associated with different capabilities, such as different numbers or sizes of antennas, different processing capabilities, and so on. Thus, one type of UE may be able to decode a shared channel using fewer repetitions than another type of UE, or may be able to synchronize using fewer synchronization signal blocks (SSBs) or reference signals (RSs) than another type of UE. Furthermore, downlink channel conditions may differ from one UE to another, which also affects the UE's ability to synchronize and to decode paging control channels or shared channels. Therefore, sub-grouping of UEs, and configuration of the arrangement of PEIs or paging occasions based at least in part on the sub-grouping of UEs, may be more resource-efficient if such sub-grouping or configuration can be performed in view of channel conditions or UE type. However, a UE subject to a paging cycle, such as an idle mode or inactive mode UE, may not have a mechanism for providing feedback regarding channel conditions or information regarding a UE type of the UE. Thus, UE sub-grouping, identification of PEI locations, identification of beams for transmission of a paging control channel, and identification of a number of repetitions for a paging communication may be inefficient or inaccessible for some UEs (e.g., lower-capability UEs, UEs in poor channel conditions).

Some techniques and apparatuses described herein provide sub-grouping of UEs (e.g., sub-grouping of paging groups of UEs) based at least in part on one or more parameters associated with a UE, such as a UE type of the UE or a measured channel condition at the UE. A UE may transmit information associated with the one or more parameters to a base station. The base station may assign the UE to a paging sub-group based at least in part on the information associated with the one or more parameters. In some aspects, the base station may determine paging transmission parameters for the UE based at least in part on the information associated with the one or more parameters, such as a PEI location, a beam where a PEI and/or a paging message is to be transmitted, a number of repetitions for a paging occasion, or the like. Thus, utilization of paging resources, and the rate of success for paging, are improved. Furthermore, paging may be feasible for lower-capability UEs and UEs in poor channel conditions, thereby improving utilization of network resources for such UEs.

In some aspects, a method of wireless communication performed by a UE includes transmitting, to a base station, information associated with one or more parameters associated with the UE, wherein the one or more parameters indicate at least one of a UE type of the UE or information relating to a measured channel condition at the UE; obtaining information indicating a configuration for a paging sub-group to which the UE is assigned, wherein the UE is assigned to the paging sub-group based at least in part on the UE type or the measured channel condition at the UE; and receiving a paging early indication (PEI) signal based at least in part on the information indicating the configuration for the paging sub-group.

In some aspects, a method of wireless communication performed by a base station includes receiving, from a UE, information associated with one or more parameters associated with the UE, wherein the one or more parameters indicate at least one of a UE type of the UE or a measured channel condition at the UE; assigning the UE to a paging sub-group based at least in part on the UE type or the measured channel condition at the UE, wherein the paging sub-group is associated with a configuration; and transmitting a PEI signal based at least in part on the configuration of the paging sub-group.

In some aspects, a UE for wireless communication includes a memory and one or more processors operatively coupled to the memory, the memory and the one or more processors configured to: transmit, to a base station, information associated with one or more parameters associated with the UE, wherein the one or more parameters indicate at least one of a UE type of the UE or information relating to a measured channel condition at the UE; obtain information indicating a configuration for a paging sub-group to which the UE is assigned, wherein the UE is assigned to the paging sub-group based at least in part on the UE type or the measured channel condition at the UE; and receive a PEI signal based at least in part on the information indicating the configuration for the paging sub-group.

In some aspects, a base station for wireless communication includes a memory and one or more processors operatively coupled to the memory, the memory and the one or more processors configured to: receive, from a UE, information associated with one or more parameters associated with the UE, wherein the one or more parameters indicate at least one of a UE type of the UE or a measured channel condition at the UE; assign the UE to a paging sub-group based at least in part on the UE type or the measured channel condition at the UE, wherein the paging sub-group is associated with a configuration; and transmit a PEI signal based at least in part on the configuration of the paging sub-group.

In some aspects, a non-transitory computer-readable medium storing a set of instructions for wireless communication includes one or more instructions that, when executed by one or more processors of a UE, cause the UE to: transmit, to a base station, information associated with one or more parameters associated with the UE, wherein the one or more parameters indicate at least one of a UE type of the UE or information relating to a measured channel condition at the UE; obtain information indicating a configuration for a paging sub-group to which the UE is assigned, wherein the UE is assigned to the paging sub-group based at least in part on the UE type or the measured channel condition at the UE; and receive a PEI signal based at least in part on the information indicating the configuration for the paging sub-group.

In some aspects, a non-transitory computer-readable medium storing a set of instructions for wireless communication includes one or more instructions that, when executed by one or more processors of a base station, cause the base station to: receive, from a UE, information associated with one or more parameters associated with the UE, wherein the one or more parameters indicate at least one of a UE type of the UE or a measured channel condition at the UE; assign the UE to a paging sub-group based at least in part on the UE type or the measured channel condition at the UE, wherein the paging sub-group is associated with a configuration; and transmit a PEI signal based at least in part on the configuration of the paging sub-group.

In some aspects, an apparatus for wireless communication includes means for transmitting, to a base station, information associated with one or more parameters associated with the apparatus, wherein the one or more parameters indicate at least one of an apparatus type of the apparatus or information relating to a measured channel condition at the apparatus; means for obtaining information indicating a configuration for a paging sub-group to which the apparatus is assigned, wherein the apparatus is assigned to the paging sub-group based at least in part on the apparatus type or the measured channel condition at the apparatus; and means for receiving a PEI signal based at least in part on the information indicating the configuration for the paging sub-group.

In some aspects, an apparatus for wireless communication includes means for receiving, from a UE, information associated with one or more parameters associated with the UE, wherein the one or more parameters indicate at least one of a UE type of the UE or a measured channel condition at the UE; means for assigning the UE to a paging sub-group based at least in part on the UE type or the measured channel condition at the UE, wherein the paging sub-group is associated with a configuration; and means for transmitting a PEI signal based at least in part on the configuration of the paging sub-group.

Aspects generally include a method, apparatus, system, computer program product, non-transitory computer-readable medium, user equipment, base station, wireless communication device, and/or processing system as substantially described with reference to and as illustrated by the drawings, specification, and appendix.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

FIG. 1 is diagram illustrating an example of a wireless network.

FIG. 2 is a diagram illustrating an example of a base station in communication with a UE in a wireless network.

FIG. 3 is a diagram illustrating an example of a paging configuration, in accordance with various aspects of the present disclosure.

FIG. 4 is a diagram illustrating examples of PEI locations for a paging cycle, in accordance with various aspects of the present disclosure.

FIG. 5 is a diagram illustrating an example of signaling associated with determination of a configuration associated with a paging sub-group based at least in part on a parameter associated with a UE, in accordance with various aspects of the present disclosure.

FIGS. 6 and 7 are flowcharts of example methods of wireless communication

FIGS. 8 and 9 is a block diagram of an example apparatus 800 for wireless communication.

FIGS. 10 and 11 are diagrams illustrating examples of a hardware implementation for an apparatus employing a processing system.

### DETAILED DESCRIPTION

The detailed description set forth below in connection with the appended drawings is intended as a description of various configurations and is not intended to represent the configurations in which the concepts described herein may be practiced. The detailed description includes specific details for the purposes of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, or the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, or the like, whether referred to as software, firmware, middleware, microcode, hardware description language, or otherwise.

Accordingly, in one or more example embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

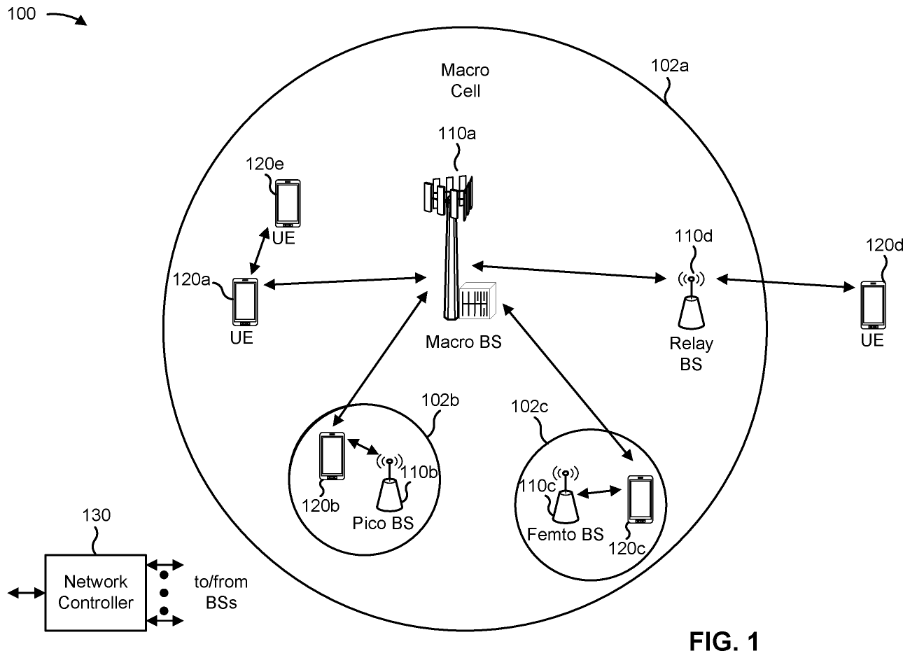

FIG. 1 is a diagram illustrating a wireless network 100 in which aspects of the present disclosure may be practiced. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as a 5G BS, a Node B, a gNB, a 5G NB, an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

ABS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “5G BS”, “gNB”, “TRP”, “AP”, “node B”, “5G NB”, and “cell” may be used interchangeably herein.

In some examples, a cell may not necessarily be stationary, and the geographic area of the cell may move according to the location of a mobile BS. In some examples, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, etc. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, etc., that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, or the like.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

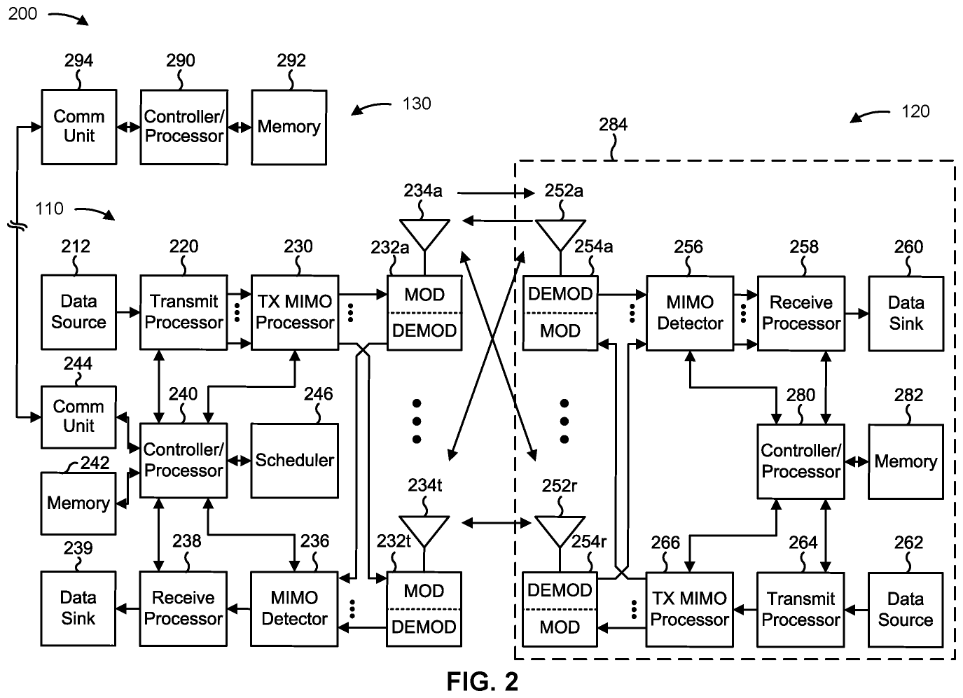

FIG. 2 is a diagram illustrating an example 200 of a base station 110 in communication with a UE 120 in a wireless network 100. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, may select a modulation and coding scheme (MCS) for each UE based at least in part on channel quality indicators (CQIs) received from the UE, process (e.g., encode and modulate) the data for each UE based at least in part on the MCS selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS), a phase tracking reference signal (PTRS), and/or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive (RX) processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a channel quality indicator (CQI) parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein. A scheduler 246 may schedule UEs for data transmission on the downlink and/or uplink.

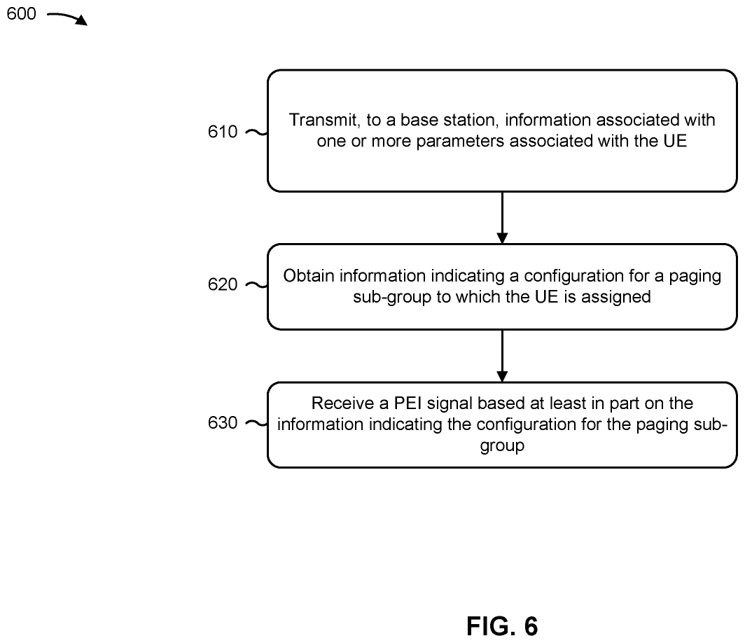

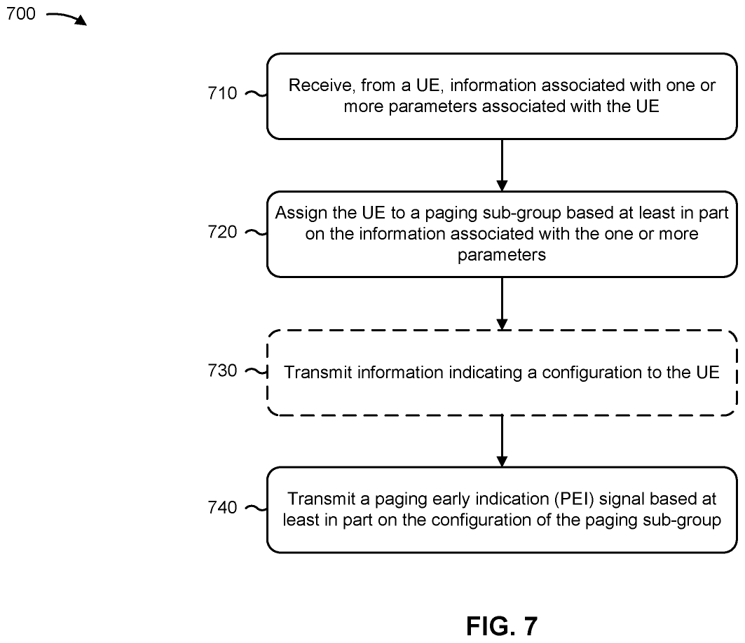

Controller/processor 240 of base station 110, controller/processor 280 of UE 120, and/or any other component(s) of FIG. 2 may perform one or more techniques associated with adaptive sub-grouping and paging for a UE, as described in more detail elsewhere herein. For example, controller/processor 240 of base station 110, controller/processor 280 of UE 120, and/or any other component(s) of FIG. 2 may perform or direct operations of, for example, method 600 of FIG. 6, method 700 of FIG. 7, and/or other processes as described herein. Memories 242 and 282 may store data and program codes for BS 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, method 600 of FIG. 6, method 700 of FIG. 7, and/or other processes as described herein. In some aspects, executing instructions may include running the instructions, converting the instructions, compiling the instructions, and/or interpreting the instructions, among other examples.

As indicated above, FIG. 2 is provided as an example. Other examples may differ from what is described with regard to FIG. 2.

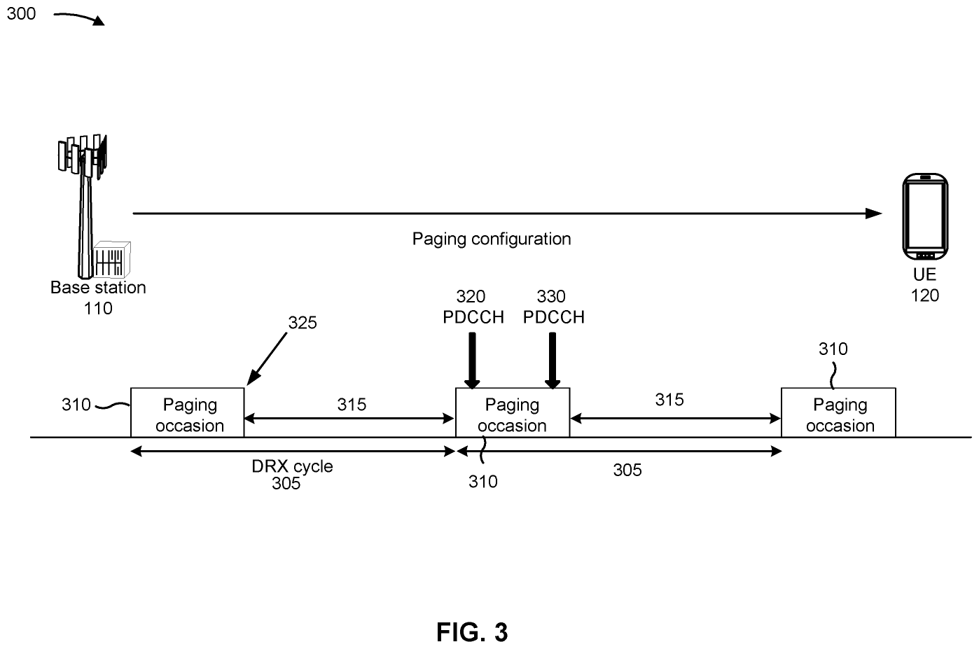

FIG. 3 is a diagram illustrating an example 300 of a paging configuration, in accordance with various aspects of the present disclosure. The paging cycle configured by the paging configuration can also be referred to as an idle-mode or inactive-mode discontinuous reception (DRX) cycle.

As shown in FIG. 3, a base station 110 may transmit a paging configuration to a UE 120 to configure a paging cycle 305 for the UE 120. For example, the base station 110 may transmit the paging configuration via a system information block (SIB) or the like. A paging cycle 305 may include a paging occasion 310 (e.g., during which a UE 120 monitors for a paging physical downlink control channel (PDCCH)) and an opportunity to enter a sleep state 315. As used herein, the time during which the UE 120 is configured to be in an active state during the paging occasion 310 may be referred to as an active time, and the time during which the UE 120 is configured to be in the sleep state 315 may be referred to as an inactive time. As described below, the UE 120 may monitor a PDCCH during the active time, and may refrain from monitoring the PDCCH during the inactive time.

In each paging frame, there may be one paging occasion for a UE to monitor. In each paging occasion, paging PDCCH occasions may be configured over all synchronization signal block (SSB) beams transmitted by the base station and repeated in time. An SSB beam is a beam used by the base station 110 to transmit an SSB.

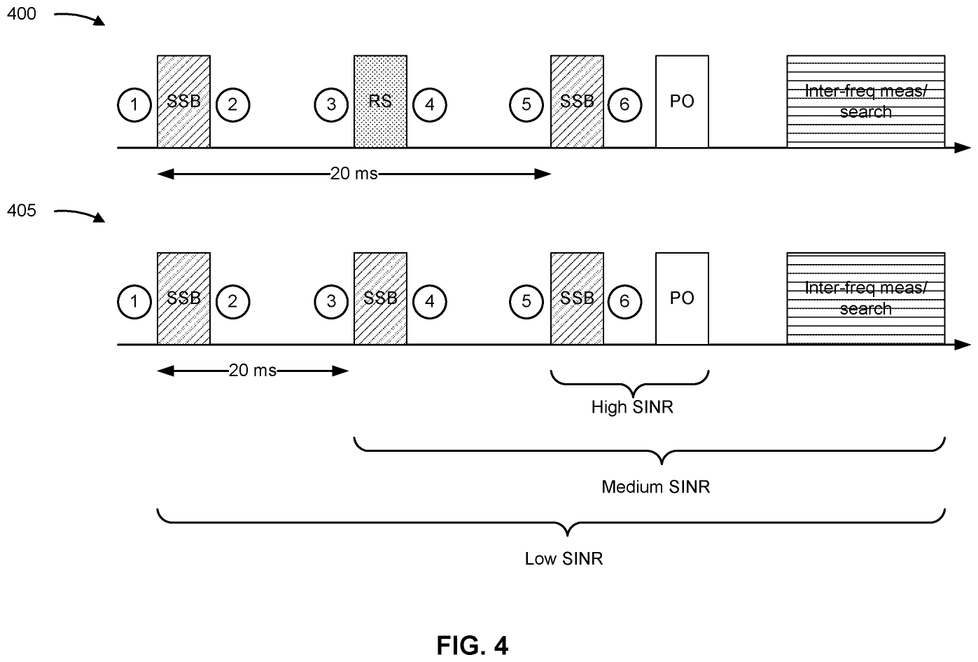

During the paging occasion 310 (e.g., the active time), the UE 120 may monitor a downlink control channel (e.g., a PDCCH), as shown by reference number 320. For example, the UE 120 may monitor the PDCCH for downlink control information (DCI) pertaining to the UE 120. In some aspects, the DCI may pertain to a UE group (also referred to as a group of UEs) to which the UE 120 belongs. In some aspects, the DCI may pertain to a sub-group of UEs. For example, a group of UEs may include all UEs associated with a given paging occasion. The group of UEs may be divided into two sub-groups of UEs. A sub-group of UEs may include less than all UEs associated with a given paging occasion. UEs in a given sub-group of UEs can be independently paged, meaning that DCI in a given paging occasion can be directed to only the UEs of the given sub-group, and not to other UEs in a group associated with the given paging occasion. Sub-grouping UEs saves paging occasion processing resources for other UEs in the group. In some cases, sub-grouping can be implemented in conjunction with a PEI, as described in connection with FIG. 4.

If the UE 120 does not detect and/or successfully decode any PDCCH communications intended for the UE 120 during the paging occasion 310, then the UE 120 may enter the sleep state 315 (e.g., for the inactive time) at the end of the paging occasion 310, as shown by reference number 325. In this way, the UE 120 may conserve battery power and reduce power consumption. As shown, the paging cycle 305 may repeat with a configured periodicity according to the paging configuration.

If the UE 120 detects and/or successfully decodes a PDCCH communication intended for the UE 120, then the UE 120 may determine a resource for a paging PDSCH based at least in part on the PDCCH communication. For example, the PDCCH communication may carry scheduling information indicating the resource for the paging PDSCH. The paging PDSCH, shown by reference number 330, may be transmitted in the paging occasion. The UE 120 may decode the paging PDSCH based at least in part on the scheduling information carried in the PDCCH communication. After receiving the PDSCH communication, the UE 120 may enter the sleep state 315 (e.g., for the inactive time). In some aspects, the paging message (e.g., the paging PDSCH) may be transmitted on all SSB beams with repetitions, similarly to the PDCCH communication, thereby ensuring coverage of idle/inactive mode UEs and improving likelihood of cell-edge reception. By operating in this manner, the UE 120 may conserve battery power and reduce power consumption by entering the sleep state 315.

As indicated above, FIG. 3 is provided as an example. Other examples may differ from what is described with respect to FIG. 3.

FIG. 4 is a diagram illustrating examples 400 and 405 of PEI locations for a paging cycle, in accordance with various aspects of the present disclosure. Example 400 is an example where reference signals (such as a tracking reference signal (TRS), a channel state information reference signal (CSI-RS), or the like) are configured for idle and inactive mode UEs. Reference signals are shown using a dotted fill. Example 405 is an example where reference signals are not configured for the purposes described herein. In examples 400 and 405, SSBs are shown by a diagonal fill. Paging occasions (e.g., paging occasions 310) are indicated by a white fill. As shown, the SSBs of examples 400 and 405 are associated with an SSB periodicity of 20 ms, though other SSB periodicities may be used.

In examples 400 and 405, potential PEI locations are shown by circled numbers 1, 2, 3, 4, 5, and 6. Numbers 1, 3, and 5 may correspond to a sequence-based PEI (e.g., a PEI that indicates a paging occasion using a sequence), whereas numbers 2, 4, and 6 may correspond to a PDCCH-based PEI (e.g., a PEI that indicates a paging occasion using DCI). Generally, PDCCH-based PEIs may occur after an SSB, since the UE may decode an SSB prior to a PDCCH-based PEI in order to update a tracking loop for PDCCH decoding. A PEI location corresponds to a time at which a PEI (also referred to herein as a PEI signal) can be transmitted.

The channel conditions at a UE may affect how many SSBs or reference signals are used by the UE to process a paging PDSCH. For example, a UE in poorer channel conditions (shown as “Low signal to interference plus noise (SINR)” and “Medium SINR”) may process more SSBs (e.g., 3 SSBs and 2 SSBs, respectively), RSs, and/or an inter-frequency measurement/search resource (shown by a horizontally hatched fill) in order to synchronize sufficiently to process a paging PDSCH. A UE in satisfactory channel conditions (shown as “High SINR”) may process fewer SSBs (e.g., 1 SSB) and may not need to process the inter-frequency measurement/search resource in order to synchronize sufficiently to process the paging PDSCH. The UE type of a UE is another factor that can affect how many SSBs or reference signals are used by the UE to process a paging PDSCH. For example, a UE associated with limited capabilities (e.g., IoT UEs, MTC UEs, RedCap UEs) may use more SSBs and/or RSs to synchronize and receive a paging PDSCH than a UE with baseline capabilities, such as an eMBB UE, a high-tier UE, or the like.

Generally, different PEI locations (e.g., circled numbers 1-6) may be beneficial in different coverage conditions. For example, PEI locations 1 and 2 may be beneficial for UEs associated with poor coverage (e.g., low SINR UEs), PEI locations 3 and 4 may be beneficial for UEs associated with medium coverage (e.g., medium SINR UEs), and PEI locations 5 and 6 may be beneficial for UEs associated with good coverage (e.g., high SINR UEs). A PEI location with a longer time separation from the paging occasion (e.g., PEI locations 1 or 2) may provide more opportunities to synchronize using multiple SSBs and/or reference signals, whereas a PEI location with a shorter time separation from the paging occasion (e.g., PEI locations 5 or 6) may enable a UE with good coverage to synchronize using a single SSB, thereby conserving power that would otherwise be used to synchronize using multiple SSBs.

In some aspects, UEs of a sub-group (e.g., a sub-group of a group associated with a paging occasion) may be associated with a PEI location. For example, the UEs of the sub-group may be configured with a mapping between the PEI location and the paging occasion. In some deployments, UE sub-grouping is performed based at least in part on UE identifiers (e.g., odd UE identifiers in a first UE sub-group and even UE identifiers in a second UE sub-group, or a similar division method). However, the sub-grouping of UEs based only on UE identifiers cannot take into account parameters associated with a UE, such as channel conditions (e.g., measured channel conditions at the UE), a UE type of the UE, or the like. As described above, such parameters can affect optimal PEI location for a UE. Thus, UE sub-grouping based only on UE identifiers may provide insufficient flexibility for arrangement of PEI locations based at least in part on channel conditions at a UE and/or capabilities of the UE, which may lead to inefficient UE resource usage and network resource usage. Techniques and apparatuses described herein provide determination of a UE sub-group based at least in part on one or more parameters associated with the UE, such as a UE type of the UE or information related to a measured channel condition at the UE. In this way, a base station can more efficiently determine parameters associated with PEI signaling and paging, such as a PEI location (and a corresponding paging sub-group), a subset of beams for a paging PDCCH and/or PDSCH, a number of repetitions for a UE's paging reception, or the like.

As indicated above, FIG. 4 is provided as an example. Other examples may differ from what is described with regard to FIG. 4.

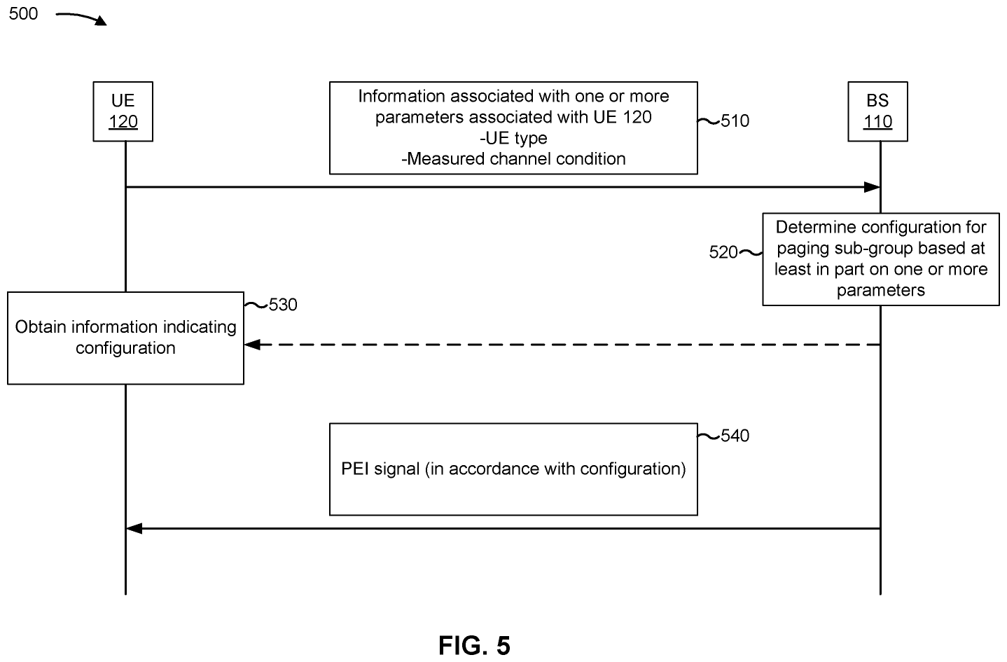

FIG. 5 is a diagram illustrating an example 500 of signaling associated with determination of a configuration associated with a paging sub-group based at least in part on a parameter associated with a UE, in accordance with various aspects of the present disclosure. As shown, example 500 includes a UE 120 and a BS 110. The UE 120 may be in an idle mode or an inactive mode (e.g., an RRC idle mode or an RRC inactive mode).

As shown in FIG. 5, and by reference number 510, the UE 120 may transmit, to the BS 110, information associated with one or more parameters associated with the UE 120. For example, the one or more parameters may indicate information associated with the UE 120, such as a UE type of the UE 120 (e.g., IoT, MTC, RedCap, eMBB, and/or the like), a measured channel condition at the UE 120, a capability of the UE 120, or the like. In some aspects, the UE 120 may transmit such information via a physical uplink shared channel (PUSCH), such as a PUSCH carrying Message 3 of a 4-step RACH procedure, a PUSCH carrying Message A of a 2-step RACH procedure, or a PUSCH in a pre-configured uplink resource (PUR). A PUR is a resource pre-configured for the UE 120 (e.g., without an active RRC connection) which the UE 120 can use to signal information to the BS 110. In some aspects, a PUR may be associated with a downlink resource which can be used by the BS 110 to signal information to the UE 120 as a response to the PUSCH transmitted by the UE in the PUR.

In some aspects, the information related to the measured channel condition at the UE 120 may relate to a measurement performed by the UE 120. For example, the UE 120 may provide information indicating a downlink channel condition at the UE 120 (e.g., a downlink channel condition report), a requested PEI location (e.g., information indicating a requested or preferred PEI location, which may be based at least in part on a channel condition at the UE 120 or a UE type of the UE 120), a requested or preferred set of SSB beams for the paging PDCCH or the paging PDSCH or the PEI, a requested number of repetitions for a paging PDCCH or a paging PDSCH or the PEI, or the like. By reporting a parameter based at least in part on the measured channel condition, the UE 120 enables the BS 110 to determine a configuration for a paging sub-group based at least in part on the parameter.

In some aspects, the UE 120 may transmit, to the BS 110, a RACH preamble. For example, the RACH preamble may be associated with a current sub-group of the UE 120 (e.g., the current sub-group of the UE 120 may be configured to provide the RACH preamble). The BS 110 may determine a measured channel condition at the UE 120 based at least in part on the RACH preamble. For example, generally, the uplink channel between the BS 110 and the UE 120 and the downlink channel between the BS 110 and the UE 120 may be reciprocal. This may mean that a degradation experienced by an uplink message can be used to infer a degradation that would be experienced by a downlink message via the same channel. The BS 110 may infer a degradation associated with a downlink message (e.g., a paging PDCCH or a paging PDSCH) to determine a measured channel condition at the UE 120, and may configure a sub-group of the UE 120 based at least in part on the inferred degradation. This may conserve resources of the UE 120 that would otherwise be used to determine the measured channel condition.

As shown by reference number 520, the BS 110 may determine a configuration for a paging sub-group for the UE 120 based at least in part on the one or more parameters indicating the UE type or the measured channel condition at the UE 120. For example, the BS 110 may assign the UE 120 to a sub-group based at least in part on the one or more parameters. For example, the BS 110 may assign the UE 120 to a sub-group associated with more robust transmission of a paging PDCCH or PDSCH if the UE 120 is associated with a low capability (e.g., IoT, MTC, RedCap), a limited number or size of antennas, or an unfavorable measured channel condition, or may assign the UE 120 to a sub-group associated with more efficient transmission of a paging PDCCH or PDSCH if the UE 120 is associated with a high capability (e.g., eMBB, high-tier), a satisfactory number or size of antennas, or a favorable measured channel condition.

As another example, the BS 110 may assign the UE 120 to a sub-group corresponding to a particular PEI location, or may configure a PEI location for a sub-group, based at least in part on the one or more parameters. For example, the BS 110 may assign the UE 120 to a sub-group associated with an earlier PEI location if the UE 120 is associated with a low capability (e.g., IoT, MTC, RedCap), a limited number or size of antennas, or an unfavorable measured channel condition, or may assign the UE 120 to a sub-group associated with a later PEI location (e.g., closer to a paging occasion) if the UE 120 is associated with a high capability (e.g., eMBB, high-tier), a satisfactory number or size of antennas, or a favorable measured channel condition.

As yet another example, the BS 110 may identify a set of beams (e.g., a subset of beams) on which to transmit a paging PDCCH or a paging PDSCH or a PEI for a sub-group, or may assign the UE 120 to a sub-group associated with a set of beams, based at least in part on the one or more parameters. For example, the BS 110 may assign the UE 120 to a sub-group associated with a particular subset of beams if the UE 120 is associated with a capability or a number or size of antennas corresponding to the particular subset of beams.

As still another example, the BS 110 may identify a number of repetitions with which to transmit a paging PDCCH or a paging PDSCH or a PEI for a sub-group, or may assign the UE 120 to a sub-group associated with a number of repetitions, based at least in part on the one or more parameters. For example, the BS 110 may assign the UE 120 to a sub-group associated with a larger number of repetitions if the UE 120 is associated with a low capability (e.g., IoT, MTC, RedCap), a limited number or size of antennas, or an unfavorable measured channel condition, or may assign the UE 120 to a sub-group associated with a smaller number of repetitions if the UE 120 is associated with a high capability (e.g., eMBB, high-tier), a satisfactory number or size of antennas, or a favorable measured channel condition.

As shown by reference number 530, the UE 120 may obtain information indicating the configuration determined by the BS 110. As used herein, “obtaining” can refer to receiving or determining. For example, in some aspects, the UE 120 may determine the configuration based at least in part on the one or more parameters signaled by the UE 120. In this case, the UE 120 may be preconfigured with information indicating a relationship between a set of parameters and a corresponding sub-group. The UE 120 may determine the corresponding sub-group based at least in part on the relationship, and may monitor a PEI and/or a paging occasion based at least in part on the corresponding sub-group.

In some aspects, the UE 120 may receive, from the BS 110, information indicating the configuration, indicated by the dashed arrow from the BS 110 to the UE 120. For example, the BS 110 may signal information indicating the configuration and/or the sub-group to which the UE 120 is assigned. In some aspects, this information may be referred to as an adjustment command.

In some aspects, the UE 120 may be assigned to an initial paging sub-group (e.g., a current paging sub-group). For example, the UE 120 may be assigned to the initial paging sub-group upon entering an idle mode or an inactive mode from a connected mode. The assignment of the UE 120 to the initial sub-group may enable the BS 110 to signal the information indicating the configuration to the UE 120. In some aspects, the BS 110 may signal the information indicating the configuration via an RRC release message (e.g., upon the UE 120 entering the idle mode or the inactive mode). In some aspects, the BS 110 may signal the information indicating the configuration via RRC signaling other than an RRC release message, such as an RRC connection setup message, an RRC reconfiguration message, or another form of RRC signaling. The information indicating the configuration can include information indicating the UE's sub-group, a PEI location, beams where the PEI and/or the paging message are transmitted, a number of repetitions for the paging PDCCH monitoring occasion in each paging occasion, or the like.

In some aspects, the BS 110 may signal the information indicating the configuration via a PDSCH. For example, the BS 110 may signal the information indicating the configuration via a PDSCH carrying a Message 4 of a 4-step RACH procedure, or via a PDSCH carrying a Message B of a 2-step RACH procedure. In some aspects, the BS 110 may signal the information indicating the configuration via a response to a PUR. For example, a PUR may be configured with a corresponding downlink resource, which the BS 110 may use to signal the information indicating the configuration. In some aspects, the BS 110 may signal the information indicating the configuration via a paging message. For example, a paging message may carry a small data transmission (SDT) indicating the configuration.

As shown by reference number 540, the UE 120 may receive, and the BS 110 may transmit, a PEI signal based at least in part on the configuration. For example, the BS 110 may determine that the UE 120 (or a paging sub-group that includes the UE 120) is to be paged. The BS 110 may determine a PEI location corresponding to the UE 120 based at least in part on the paging sub-group assigned to the UE 120. The BS 110 may transmit a PEI signal at the PEI location. The UE 120 may receive the PEI signal at the PEI location, and may monitor a set of SSBs and/or RSs based at least in part on receiving the PEI signal. The UE 120 may synchronize based at least in part on the set of SSBs and/or RSs, and may monitor a paging occasion (e.g., on one or more beams specified by the configuration and/or based at least in part on a number of repetitions specified by the configuration) corresponding to the sub-group based at least in part on receiving the PEI signal and based at least in part on the synchronization. If the UE 120 decodes DCI on the paging occasion directed to the paging sub-group of the UE 120, the UE 120 may receive a corresponding PDSCH (e.g., on one or more beams specified by the configuration and/or based at least in part on a number of repetitions specified by the configuration) as indicated by the DCI. In this way, the BS 110 can assign the UE 120 to a sub-group, and/or configure a sub-group, based at least in part on parameters associated with the UE 120. By assigning and/or configuring the sub-group based at least in part on the parameters, such as a UE type and/or a measured configuration at the UE 120, the BS 110 can more accurately account for channel conditions, capabilities of the UE 120, and so on. Thus, utilization of network resources and the rate of success of PEI signaling and paging are improved.

As indicated above, FIG. 5 is provided as an example. Other examples may differ from what is described with regard to FIG. 5.

FIG. 6 is a flowchart of an example method 600 of wireless communication. The method 600 may be performed by, for example, a user equipment (UE) (e.g., UE 120).

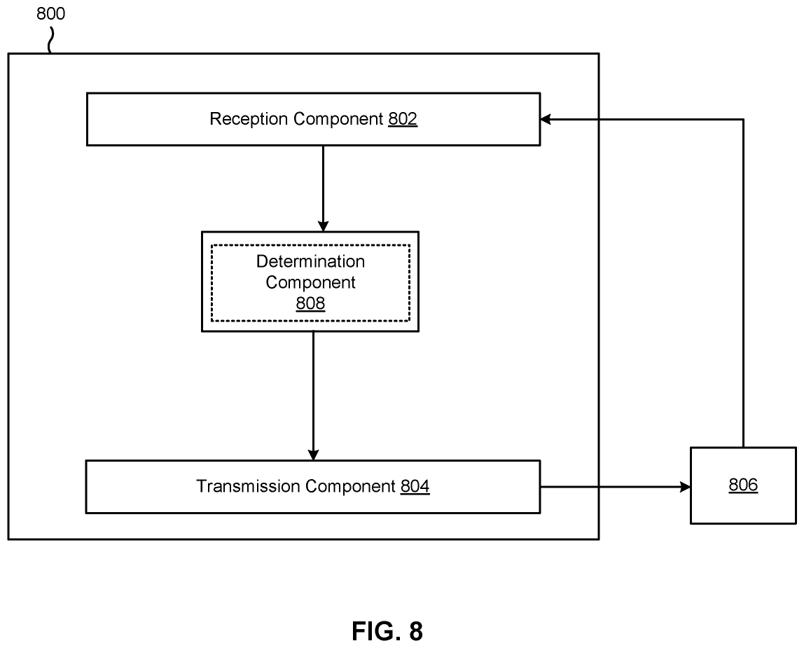

At 610, the UE may transmit, to a base station, information associated with one or more parameters associated with the UE. For example, the UE (e.g., using transmission component 804, depicted in FIG. 8) may transmit, to a base station, information associated with one or more parameters associated with the UE. The one or more parameters may indicate at least one of a UE type of the UE, or information relating to a measured channel condition at the UE, as described above in connection with, for example, FIG. 5 and at 510.

In some aspects, the UE type indicates whether the UE is a reduced capability UE, an Internet of Things UE, a machine-type communication UE, or an enhanced mobile broadband UE. In some aspects, the UE may additionally or alternatively transmit capability information indicating a capability of the UE, such as a number of antennas, a size of antennas, or the like.

In some aspects, the information associated with the one or more parameters includes a random access channel associated with a preamble, and the UE is assigned to a paging sub-group based at least in part on the random access channel associated with the preamble. In some aspects, the preamble is associated with a current paging sub-group of the UE (e.g., an initial paging sub-group).

In some aspects, the information relating to the measured channel condition includes information indicating a channel condition associated with the UE. In some aspects, the information relating to the measured channel condition includes information indicating one or more preferred beams for a synchronization signal block. In some aspects, the information relating to the measured channel condition includes information indicating a requested location for the PEI signal. “Location for a/the PEI signal” is used interchangeably with “PEI location” herein. In some aspects, the information relating to the measured channel condition includes information indicating a number of repetitions for the PEI signal or the paging message.

In some aspects, the information associated with the one or more parameters is transmitted via an uplink shared channel carrying a random access channel (RACH) message. In some aspects, the random access channel message is a RACH message 3 for a radio resource control (RRC) connection request or a RACH message A for a two-step RACH procedure. In some aspects, the information associated with the one or more parameters is transmitted via an uplink shared channel in a pre-configured uplink resource associated with the UE.

At 620, the UE may obtain information indicating a configuration for a paging sub-group to which the UE is assigned. For example, the UE (e.g., using reception component 802 or determination component 808, depicted in FIG. 8) may obtain information indicating a configuration for a paging sub-group to which the UE is assigned, wherein the UE is assigned to the paging sub-group based at least in part on the UE type or the measured channel condition at the UE, as described above in connection with, for example, FIG. 5 and at 530. “Paging sub-group” is used interchangeably with “sub-group” herein. In some aspects, the paging sub-group is a sub-group of a group of UEs associated with a paging occasion and the group of UEs can be paged by a network in the paging occasion. “Group of UEs” is used interchangeably with “paging group” herein. In some aspects, the configuration indicates at least one of the paging sub-group, a location for the PEI signal, a set of beams for transmission of the PEI signal, a set of beams for transmission of a corresponding paging message, or a number of repetitions of a monitoring occasion associated with a paging occasion for the corresponding paging message.

In some aspects, obtaining the information indicating the configuration further comprises determining the information indicating the configuration based at least in part on the information associated with the one or more parameters. For example, the UE may determine the information indicating the configuration (e.g., based at least in part on a preconfiguration), as described above.

In some aspects, obtaining the information indicating the configuration further comprises receiving the information indicating the configuration from the base station. In some aspects, the information indicating the configuration is received in connection with a radio resource control release message. In some aspects, the information indicating the configuration is received via radio resource control signaling other than a radio resource control release message. In some aspects, the information indicating the configuration is received via a downlink shared channel associated with a random access channel message (e.g., a PDSCH carrying a RACH Message 4 or a RACH Message B). In some aspects, the information indicating the configuration is received via a physical downlink control channel associated with a preconfigured uplink resource of the UE. In some aspects, the information indicating the configuration is received in a paging message to the UE.

At 630, the UE may receive a PEI signal based at least in part on the information indicating the configuration for the paging sub-group. For example, the UE (e.g., using reception component 802, depicted in FIG. 8) may receive a PEI signal based at least in part on the information indicating the configuration for the paging sub-group, as described above in connection with, for example, FIG. 5 and at 540. In some aspects, the UE may receive a paging message (where “paging message” can include a paging PDCCH and/or a paging PDSCH) based at least in part on the PEI signal, as described elsewhere herein.

Although FIG. 6 shows example blocks of method 600, in some aspects, method 600 may include additional blocks, fewer blocks, different blocks, or differently arranged blocks than those depicted in FIG. 6. Additionally, or alternatively, two or more of the blocks of method 600 may be performed in parallel.

FIG. 7 is a flowchart of an example method 700 of wireless communication. The method 700 may be performed by, for example, a base station (e.g., base station 110).

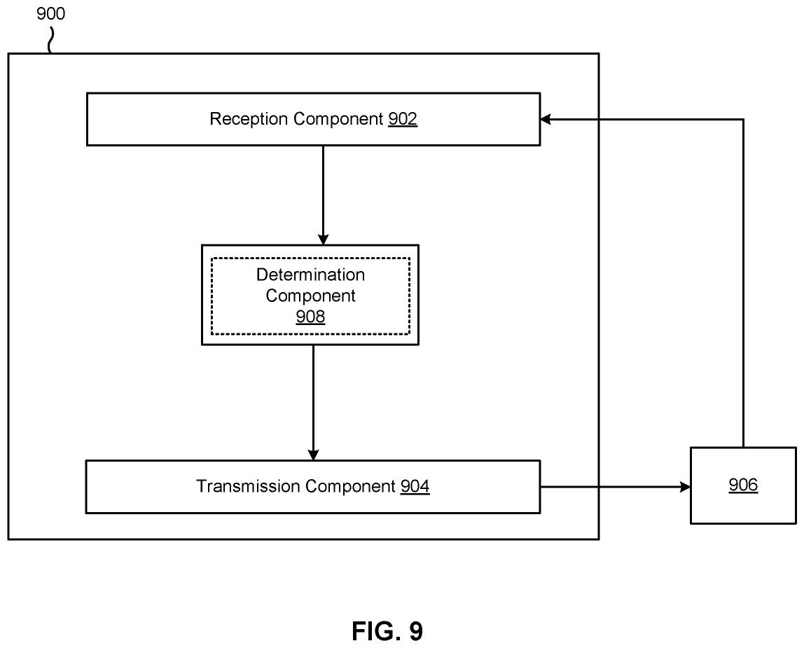

At 710, the base station may receive, from a UE, information associated with one or more parameters associated with the UE. For example, the base station (e.g., using reception component 902, depicted in FIG. 9) may receive, from a UE, information associated with one or more parameters associated with the UE, wherein the one or more parameters indicate at least one of a UE type of the UE or a measured channel condition at the UE, as described above in connection with, for example, FIG. 5 and at 510.

In some aspects, the UE type indicates whether the UE is a reduced capability UE, an Internet of Things UE, a machine-type communication UE, or an enhanced mobile broadband UE. In some aspects, the information associated with the one or more parameters includes a random access channel associated with a preamble, and the UE is assigned to the paging sub-group based at least in part on the random access channel associated with the preamble. For example, the preamble may be associated with a current paging sub-group of the UE.

In some aspects, the information relating to the measured channel condition includes information indicating a channel condition associated with the UE (e.g., a downlink channel condition). In some aspects, the information relating to the measured channel condition includes information indicating one or more preferred beams for a synchronization signal block. In some aspects, the information relating to the measured channel condition includes information indicating a requested location for the PEI signal. In some aspects, the information relating to the measured channel condition includes information indicating a number of repetitions for the PEI signal or the paging message.

In some aspects, the information associated with the one or more parameters is transmitted via an uplink shared channel carrying a RACH message. For example, the random access channel message may be a RACH message 3 for a radio resource control (RRC) connection request or a RACH message A for a two-step RACH procedure. In some aspects, the information associated with the one or more parameters is received via an uplink shared channel in a pre-configured uplink resource associated with the UE.

At 720, the base station may assign the UE to a paging sub-group based at least in part on the UE type or the measured channel condition at the UE. For example, the base station (e.g., using determination component 908, depicted in FIG. 9) may assign the UE to a paging sub-group based at least in part on the UE type or the measured channel condition at the UE, wherein the paging sub-group is associated with a configuration, as described above in connection with, for example, FIG. 5 and at 520. In some aspects, the paging sub-group is a sub-group of a group of UEs associated with a paging occasion and the group of UEs can be paged by the base station in the paging occasion. In some aspects, the configuration indicates at least one of the paging sub-group, a location for the PEI signal, a set of beams for transmission of the PEI signal, a set of beams for transmission of a corresponding paging message, or a number of repetitions of a monitoring occasion associated with a paging occasion for the corresponding paging message. In some aspects, method 700 includes determining the configuration based at least in part on the information associated with the one or more parameters.

At 730, the base station may optionally (as indicated by the dashed border) transmit information indicating the configuration to the UE. In some aspects, the information indicating the configuration is transmitted in connection with a radio resource control release message. In some aspects, the information indicating the configuration is transmitted via radio resource control signaling other than a radio resource control release message. In some aspects, the information indicating the configuration is transmitted via a downlink shared channel associated with a random access channel message. In some aspects, the information indicating the configuration is transmitted via a physical downlink control channel associated with a preconfigured uplink resource of the UE. In some aspects, the information indicating the configuration is transmitted in a paging message to the UE.

At 740, the base station may transmit a PEI signal based at least in part on the configuration of the paging sub-group. For example, the base station (e.g., using transmission component 904, depicted in FIG. 9) may transmit a PEI signal based at least in part on the configuration of the paging sub-group, as described above in connection with, for example, FIG. 5 and at 540. In some aspects, the base station may transmit a paging message (e.g., a paging PDCCH or a paging PDSCH) based at least in part on the paging sub-group, as described in more detail elsewhere herein.

Although FIG. 7 shows example blocks of method 700, in some aspects, method 700 may include additional blocks, fewer blocks, different blocks, or differently arranged blocks than those depicted in FIG. 7. Additionally, or alternatively, two or more of the blocks of method 700 may be performed in parallel.

FIG. 8 is a block diagram of an example apparatus 800 for wireless communication. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include a determination component 808, among other examples.

In some aspects, the apparatus 800 may be configured to perform one or more operations described herein in connection with FIGS. 3-5. Additionally, or alternatively, the apparatus 800 may be configured to perform one or more processes described herein, such as method 600 of FIG. 6, or a combination thereof. In some aspects, the apparatus 800 and/or one or more components shown in FIG. 8 may include one or more components of the UE described above in connection with FIG. 2. Additionally, or alternatively, one or more components shown in FIG. 8 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 806. In some aspects, the reception component 802 may include one or more antennas, a demodulator, a MIMO detector, a receive processor, a controller/processor, a memory, or a combination thereof, of the UE described above in connection with FIG. 2.

The transmission component 804 may transmit communications, such as reference signals, control information, data communications, or a combination thereof, to the apparatus 806. In some aspects, one or more other components of the apparatus 806 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modulator, a transmit MIMO processor, a transmit processor, a controller/processor, a memory, or a combination thereof, of the UE described above in connection with FIG. 2. In some aspects, the transmission component 804 may be co-located with the reception component 802 in a transceiver.

The transmission component 804 may transmit, to a base station, information associated with one or more parameters associated with the UE, wherein the one or more parameters indicate at least one of a UE type of the UE or information relating to a measured channel condition at the UE. The reception component 802 or the determination component 808 may obtain information indicating a configuration for a paging sub-group to which the UE is assigned, wherein the UE is assigned to the paging sub-group based at least in part on the UE type or the measured channel condition at the UE. The reception component 802 may receive a PEI signal based at least in part on the information indicating the configuration for the paging sub-group.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a block diagram of an example apparatus 900 for wireless communication. The apparatus 900 may be a base station, or a base station may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include a determination component 908, among other examples.

In some aspects, the apparatus 900 may be configured to perform one or more operations described herein in connection with FIGS. 3-5. Additionally, or alternatively, the apparatus 900 may be configured to perform one or more processes described herein, such as method 700 of FIG. 7, or a combination thereof. In some aspects, the apparatus 900 and/or one or more components shown in FIG. 9 may include one or more components of the base station described above in connection with FIG. 2. Additionally, or alternatively, one or more components shown in FIG. 9 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 906. In some aspects, the reception component 902 may include one or more antennas, a demodulator, a MIMO detector, a receive processor, a controller/processor, a memory, or a combination thereof, of the base station described above in connection with FIG. 2.

The transmission component 904 may transmit communications, such as reference signals, control information, data communications, or a combination thereof, to the apparatus 906. In some aspects, one or more other components of the apparatus 906 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modulator, a transmit MIMO processor, a transmit processor, a controller/processor, a memory, or a combination thereof, of the base station described above in connection with FIG. 2. In some aspects, the transmission component 904 may be co-located with the reception component 902 in a transceiver.

The reception component 902 may receive, from a UE, information associated with one or more parameters associated with the UE, wherein the one or more parameters indicate at least one of a UE type of the UE or a measured channel condition at the UE. The determination component 908 may assign the UE to a paging sub-group based at least in part on the UE type or the measured channel condition at the UE, wherein the paging sub-group is associated with a configuration. The transmission component 904 may transmit a PEI signal based at least in part on the configuration of the paging sub-group. The determination component 908 may determine the configuration based at least in part on the information associated with the one or more parameters. The transmission component 904 may transmit information indicating the configuration to the UE.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

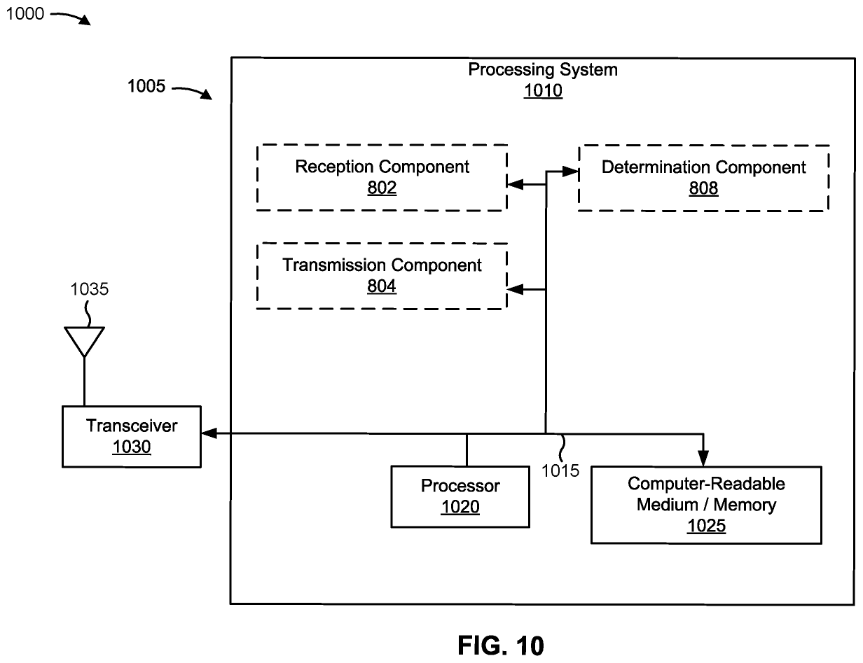

FIG. 10 is a diagram illustrating an example 1000 of a hardware implementation for an apparatus 1005 employing a processing system 1010. The apparatus 1005 may be a UE.

The processing system 1010 may be implemented with a bus architecture, represented generally by the bus 1015. The bus 1015 may include any number of interconnecting buses and bridges depending on the specific application of the processing system 1010 and the overall design constraints. The bus 1015 links together various circuits including one or more processors and/or hardware components, represented by the processor 1020, the illustrated components, and the computer-readable medium/memory 1025. The bus 1015 may also link various other circuits, such as timing sources, peripherals, voltage regulators, power management circuits, and/or the like.

The processing system 1010 may be coupled to a transceiver 1030. The transceiver 1030 is coupled to one or more antennas 1035. The transceiver 1030 provides a means for communicating with various other apparatuses over a transmission medium. The transceiver 1030 receives a signal from the one or more antennas 1035, extracts information from the received signal, and provides the extracted information to the processing system 1010, specifically the reception component 802. In addition, the transceiver 1030 receives information from the processing system 1010, specifically the transmission component 804, and generates a signal to be applied to the one or more antennas 1035 based at least in part on the received information.

The processing system 1010 includes a processor 1020 coupled to a computer-readable medium/memory 1025. The processor 1020 is responsible for general processing, including the execution of software stored on the computer-readable medium/memory 1025. The software, when executed by the processor 1020, causes the processing system 1010 to perform the various functions described herein for any particular apparatus. The computer-readable medium/memory 1025 may also be used for storing data that is manipulated by the processor 1020 when executing software. The processing system further includes at least one of the illustrated components. The components may be software modules running in the processor 1020, resident/stored in the computer readable medium/memory 1025, one or more hardware modules coupled to the processor 1020, or some combination thereof.

In some aspects, the processing system 1010 may be a component of the UE 120 and may include the memory 282 and/or at least one of the TX MIMO processor 266, the RX processor 258, and/or the controller/processor 280. In some aspects, the apparatus 1005 for wireless communication includes means for transmitting, to a base station, information associated with one or more parameters associated with the apparatus 1005, wherein the one or more parameters indicate at least one of a UE type of the apparatus 1005 or information relating to a measured channel condition at the apparatus 1005; means for obtaining information indicating a configuration for a paging sub-group to which the apparatus 1005 is assigned, wherein the apparatus 1005 is assigned to the paging sub-group based at least in part on the UE type or the measured channel condition at the apparatus 1005; and means for receiving a PEI signal based at least in part on the information indicating the configuration for the paging sub-group. The aforementioned means may be one or more of the aforementioned components of the apparatus 800 and/or the processing system 1010 of the apparatus 1005 configured to perform the functions recited by the aforementioned means. As described elsewhere herein, the processing system 1010 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 10 is provided as an example. Other examples may differ from what is described in connection with FIG. 10.

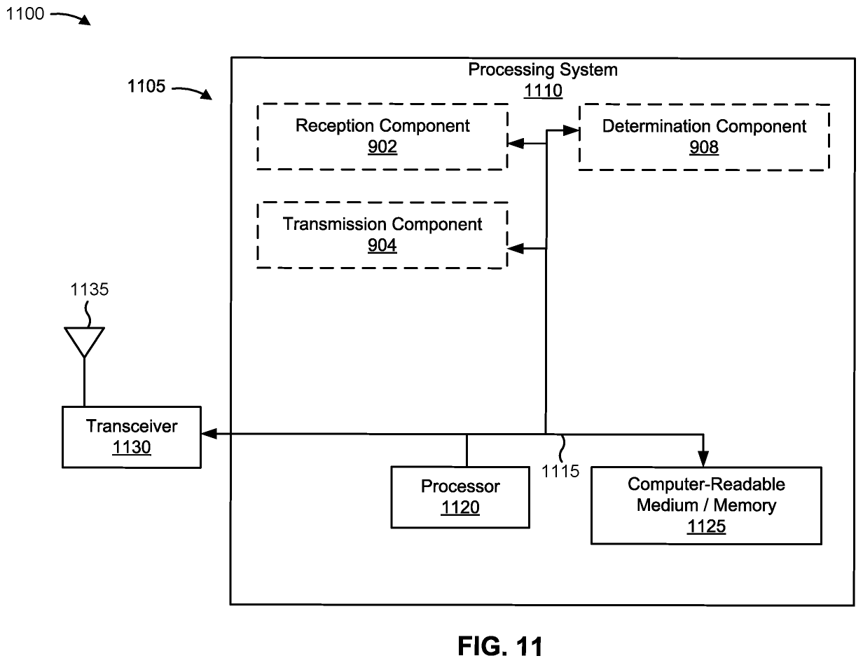

FIG. 11 is a diagram illustrating an example 1100 of a hardware implementation for an apparatus 1105 employing a processing system 1110. The apparatus 1105 may be a base station.

The processing system 1110 may be implemented with a bus architecture, represented generally by the bus 1115. The bus 1115 may include any number of interconnecting buses and bridges depending on the specific application of the processing system 1110 and the overall design constraints. The bus 1115 links together various circuits including one or more processors and/or hardware components, represented by the processor 1120, the illustrated components, and the computer-readable medium/memory 1125. The bus 1115 may also link various other circuits, such as timing sources, peripherals, voltage regulators, power management circuits, and/or the like.

The processing system 1110 may be coupled to a transceiver 1130. The transceiver 1130 is coupled to one or more antennas 1135. The transceiver 1130 provides a means for communicating with various other apparatuses over a transmission medium. The transceiver 1130 receives a signal from the one or more antennas 1135, extracts information from the received signal, and provides the extracted information to the processing system 1110, specifically the reception component 902. In addition, the transceiver 1130 receives information from the processing system 1110, specifically the transmission component 904, and generates a signal to be applied to the one or more antennas 1135 based at least in part on the received information.

The processing system 1110 includes a processor 1120 coupled to a computer-readable medium/memory 1125. The processor 1120 is responsible for general processing, including the execution of software stored on the computer-readable medium/memory 1125. The software, when executed by the processor 1120, causes the processing system 1110 to perform the various functions described herein for any particular apparatus. The computer-readable medium/memory 1125 may also be used for storing data that is manipulated by the processor 1120 when executing software. The processing system further includes at least one of the illustrated components. The components may be software modules running in the processor 1120, resident/stored in the computer readable medium/memory 1125, one or more hardware modules coupled to the processor 1120, or some combination thereof.

In some aspects, the processing system 1110 may be a component of the base station 110 and may include the memory 242 and/or at least one of the TX MIMO processor 230, the RX processor 238, and/or the controller/processor 240. In some aspects, the apparatus 1105 for wireless communication includes means for receiving, from a UE, information associated with one or more parameters associated with the UE, wherein the one or more parameters indicate at least one of a UE type of the UE or a measured channel condition at the UE; assigning the UE to a paging sub-group based at least in part on the UE type or the measured channel condition at the UE, wherein the paging sub-group is associated with a configuration; and transmitting a PEI signal based at least in part on the configuration of the paging sub-group. The aforementioned means may be one or more of the aforementioned components of the apparatus 900 and/or the processing system 1110 of the apparatus 1105 configured to perform the functions recited by the aforementioned means. As described elsewhere herein, the processing system 1110 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 11 is provided as an example. Other examples may differ from what is described in connection with FIG. 11.

The following provides an overview of aspects of the present disclosure:

Aspect 1: A method of wireless communication performed by a user equipment (UE), comprising: transmitting, to a base station, information associated with one or more parameters associated with the UE, wherein the one or more parameters indicate at least one of a UE type of the UE or information relating to a measured channel condition at the UE; obtaining information indicating a configuration for a paging sub-group to which the UE is assigned, wherein the UE is assigned to the paging sub-group based at least in part on the UE type or the measured channel condition at the UE; and receiving a paging early indication (PEI) signal based at least in part on the information indicating the configuration for the paging sub-group.

Aspect 2: The method of aspect 1, wherein the UE type indicates whether the UE is a reduced capability UE, an Internet of Things UE, a machine-type communication UE, or an enhanced mobile broadband UE.

Aspect 3: The method of any of aspects 1-2, wherein the information associated with the one or more parameters includes a random access channel associated with a preamble, and wherein the UE is assigned to the paging sub-group based at least in part on the random access channel associated with the preamble.

Aspect 4: The method of aspect 3, wherein the preamble is associated with a current paging sub-group of the UE.

Aspect 5: The method of any of aspects 1-4, wherein the information relating to the measured channel condition includes information indicating a channel condition associated with the UE.

Aspect 6: The method of any of aspects 1-5, wherein the information relating to the measured channel condition includes information indicating one or more preferred beams for a synchronization signal block.

Aspect 7: The method of any of aspects 1-6, wherein the information relating to the measured channel condition includes information indicating a requested location for the PEI signal.

Aspect 8: The method of any of aspects 1-7, wherein the information relating to the measured channel condition includes information indicating a number of repetitions for the PEI signal or the paging message.

Aspect 9: The method of any of aspects 1-8, wherein the information associated with the one or more parameters is transmitted via an uplink shared channel carrying a random access channel (RACH) message.

Aspect 10: The method of aspect 9, wherein the random access channel message is a RACH message 3 for a radio resource control (RRC) connection request or a RACH message A for a two-step RACH procedure.

Aspect 11: The method of any of aspects 1-8, wherein the information associated with the one or more parameters is transmitted via an uplink shared channel in a pre-configured uplink resource associated with the UE.

Aspect 12: The method of any of aspects 1-11, wherein the paging sub-group is a sub-group of a group of UEs associated with a paging occasion and the group of UEs can be paged by a network in the paging occasion.

Aspect 13: The method of any of aspects 1-12, wherein the configuration indicates at least one of: the paging sub-group, a location for the PEI signal, a set of beams for transmission of the PEI signal, a set of beams for transmission of a corresponding paging message, or a number of repetitions of a monitoring occasion associated with a paging occasion for the corresponding paging message.

Aspect 14: The method of any of aspects 1-13, wherein obtaining the information indicating the configuration further comprises: determining the information indicating the configuration based at least in part on the information associated with the one or more parameters.

Aspect 15: The method of any of aspects 1-14, wherein obtaining the information indicating the configuration further comprises: receiving the information indicating the configuration from the base station.

Aspect 16: The method of aspect 15, wherein the information indicating the configuration is received in connection with a radio resource control release message.

Aspect 17: The method of aspect 15, wherein the information indicating the configuration is received via radio resource control signaling other than a radio resource control release message.

Aspect 18: The method of aspect 15, wherein the information indicating the configuration is received via a downlink shared channel associated with a random access channel message.

Aspect 19: The method of aspect 15, wherein the information indicating the configuration is received via a physical downlink control channel associated with a preconfigured uplink resource of the UE.

Aspect 20: The method of aspect 15, wherein the information indicating the configuration is received in a paging message to the UE.

Aspect 21: A method of wireless communication performed by a base station, comprising: receiving, from a user equipment (UE), information associated with one or more parameters associated with the UE, wherein the one or more parameters indicate at least one of a UE type of the UE or a measured channel condition at the UE; assigning the UE to a paging sub-group based at least in part on the UE type or the measured channel condition at the UE, wherein the paging sub-group is associated with a configuration; and transmitting a paging early indication (PEI) signal based at least in part on the configuration of the paging sub-group.

Aspect 22: The method of aspect 21, wherein the UE type indicates whether the UE is a reduced capability UE, an Internet of Things UE, a machine-type communication UE, or an enhanced mobile broadband UE.

Aspect 23: The method of any of aspects 21-22, wherein the information associated with the one or more parameters includes a random access channel associated with a preamble, and wherein the UE is assigned to the paging sub-group based at least in part on the random access channel associated with the preamble.

Aspect 24: The method of aspect 23, wherein the preamble is associated with a current paging sub-group of the UE.

Aspect 25: The method of any of aspects 21-24, wherein the information relating to the measured channel condition includes information indicating a channel condition associated with the UE.

Aspect 26: The method of any of aspects 21-25, wherein the information relating to the measured channel condition includes information indicating one or more preferred beams for a synchronization signal block.

Aspect 27: The method of any of aspects 21-26, wherein the information relating to the measured channel condition includes information indicating a requested location for the PEI signal.

Aspect 28: The method of any of aspects 21-27, wherein the information relating to the measured channel condition includes information indicating a number of repetitions for the PEI signal or the paging message.

Aspect 29: The method of any of aspects 21-28, wherein the information associated with the one or more parameters is transmitted via an uplink shared channel carrying a random access channel (RACH) message.

Aspect 30: The method of aspect 29, wherein the random access channel message is a RACH message 3 for a radio resource control (RRC) connection request or a RACH message A for a two-step RACH procedure.

Aspect 31: The method of any of aspects 21-28, wherein the information associated with the one or more parameters is received via an uplink shared channel in a pre-configured uplink resource associated with the UE.

Aspect 32: The method of any of aspects 21-31, wherein the paging sub-group is a sub-group of a group of UEs associated with a paging occasion and the group of UEs can be paged by the base station in the paging occasion.

Aspect 33: The method of any of aspects 21-32, wherein the configuration indicates at least one of: the paging sub-group, a location for the PEI signal, a set of beams for transmission of the PEI signal, a set of beams for transmission of a corresponding paging message, or a number of repetitions of a monitoring occasion associated with a paging occasion for the corresponding paging message.

Aspect 34: The method of any of aspects 21-33, further comprising: determining the configuration based at least in part on the information associated with the one or more parameters.

Aspect 35: The method of any of aspects 21-34, further comprising: transmitting information indicating the configuration to the UE.

Aspect 36: The method of aspect 35, wherein the information indicating the configuration is transmitted in connection with a radio resource control release message.

Aspect 37: The method of aspect 35, wherein the information indicating the configuration is transmitted via radio resource control signaling other than a radio resource control release message.

Aspect 38: The method of aspect 35, wherein the information indicating the configuration is transmitted via a downlink shared channel associated with a random access channel message.

Aspect 39: The method of aspect 35, wherein the information indicating the configuration is transmitted via a physical downlink control channel associated with a preconfigured uplink resource of the UE.

Aspect 40: The method of aspect 35, wherein the information indicating the configuration is transmitted in a paging message to the UE.

Aspect 41: An apparatus for wireless communication at a device, comprising a processor; memory coupled with the processor; and instructions stored in the memory and executable by the processor to cause the apparatus to perform the method of one or more aspects of aspects 1-40.

Aspect 42: A device for wireless communication, comprising a memory and one or more processors coupled to the memory, the memory and the one or more processors configured to perform the method of one or more aspects of aspects 1-40.

Aspect 43: An apparatus for wireless communication, comprising at least one means for performing the method of one or more aspects of aspects 1-40.

Aspect 44: A non-transitory computer-readable medium storing code for wireless communication, the code comprising instructions executable by a processor to perform the method of one or more aspects of aspects 1-40.

Aspect 45: A non-transitory computer-readable medium storing a set of instructions for wireless communication, the set of instructions comprising one or more instructions that, when executed by one or more processors of a device, cause the device to perform the method of one or more aspects of aspects 1-40.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
transmitting, to a base station, information associated with one or more parameters associated with the UE, wherein the one or more parameters indicate at least one of a UE type of the UE or information relating to a measured channel condition at the UE;
obtaining information indicating a configuration for a paging sub-group to which the UE is assigned, wherein the UE is assigned to the paging sub-group based at least in part on the UE type or the measured channel condition at the UE; and
receiving a paging early indication (PEI) signal based at least in part on the information indicating the configuration for the paging sub-group.

2. The method of claim 1, wherein the UE type indicates whether the UE is a reduced capability UE, an Internet of Things UE, a machine-type communication UE, or an enhanced mobile broadband UE.

3. The method of claim 1, wherein the information associated with the one or more parameters includes a random access channel associated with a preamble, and wherein the UE is assigned to the paging sub-group based at least in part on the random access channel associated with the preamble.

4. The method of claim 3, wherein the preamble is associated with a current paging sub-group of the UE.

5. The method of claim 1, wherein the information relating to the measured channel condition includes information indicating a channel condition associated with the UE.

6. The method of claim 1, wherein the information relating to the measured channel condition includes information indicating one or more preferred beams for a synchronization signal block.

7. The method of claim 1, wherein the information relating to the measured channel condition includes information indicating a requested location for the PEI signal.

8. The method of claim 1, wherein the information relating to the measured channel condition includes information indicating a number of repetitions for the PEI signal or a paging message associated with the PEI signal.

9. The method of claim 1, wherein the information associated with the one or more parameters is transmitted via an uplink shared channel carrying a random access channel (RACH) message.

10. The method of claim 9, wherein the random access channel message is a RACH message 3 for a radio resource control (RRC) connection request or a RACH message A for a two-step RACH procedure.

11. The method of claim 1, wherein the information associated with the one or more parameters is transmitted via an uplink shared channel in a pre-configured uplink resource associated with the UE.

12. The method of claim 1, wherein the paging sub-group is a sub-group of a group of UEs associated with a paging occasion and the group of UEs can be paged by a network in the paging occasion.

13. The method of claim 1, wherein the configuration indicates at least one of:
the paging sub-group,
a location for the PEI signal,
a set of beams for transmission of the PEI signal,
a set of beams for transmission of a corresponding paging message, or
a number of repetitions of a monitoring occasion associated with a paging occasion for the corresponding paging message.

14. The method of claim 1, wherein obtaining the information indicating the configuration further comprises:
determining the information indicating the configuration based at least in part on the information associated with the one or more parameters.

15. The method of claim 1, wherein obtaining the information indicating the configuration further comprises:
receiving the information indicating the configuration from the base station.

16. The method of claim 15, wherein the information indicating the configuration is received in connection with a radio resource control release message.

17. The method of claim 15, wherein the information indicating the configuration is received via radio resource control signaling other than a radio resource control release message.

18. The method of claim 15, wherein the information indicating the configuration is received via a downlink shared channel associated with a random access channel (RACH) message, wherein the random access channel message includes a Message 4 for a four-step RACH procedure or a Message B for a two-step RACH procedure.

19. The method of claim 15, wherein the information indicating the configuration is received via a physical downlink control channel associated with a preconfigured uplink resource of the UE.

20. The method of claim 15, wherein the information indicating the configuration is received in a paging message to the UE.

21. A method of wireless communication performed by a base station, comprising:
receiving, from a user equipment (UE), information associated with one or more parameters associated with the UE, wherein the one or more parameters indicate at least one of a UE type of the UE or a measured channel condition at the UE;
assigning the UE to a paging sub-group based at least in part on the UE type or the measured channel condition at the UE, wherein the paging sub-group is associated with a configuration; and
transmitting a paging early indication (PEI) signal based at least in part on the configuration of the paging sub-group.

22. The method of claim 21, wherein the information relating to the measured channel condition includes information indicating a channel condition associated with the UE.

23. The method of claim 21, wherein the information relating to the measured channel condition includes information indicating one or more preferred beams for a synchronization signal block.

24. The method of claim 21, wherein the information relating to the measured channel condition includes information indicating a requested location for the PEI signal.

25. The method of claim 21, wherein the information relating to the measured channel condition includes information indicating a number of repetitions for the PEI signal or a paging message associated with the PEI signal.

26. The method of claim 21, further comprising:
determining the configuration based at least in part on the information associated with the one or more parameters.

27. The method of claim 21, further comprising:
transmitting information indicating the configuration to the UE.

28. A user equipment (UE) for wireless communication, comprising:
a memory; and
one or more processors operatively coupled to the memory, the memory and the one or more processors configured to:
transmit, to a base station, information associated with one or more parameters associated with the UE, wherein the one or more parameters indicate at least one of a UE type of the UE or information relating to a measured channel condition at the UE;
obtain information indicating a configuration for a paging sub-group to which the UE is assigned, wherein the UE is assigned to the paging sub-group based at least in part on the UE type or the measured channel condition at the UE; and
receive a paging early indication (PEI) signal based at least in part on the information indicating the configuration for the paging sub-group.

29. The UE of claim 28, wherein the one or more processors, when obtaining the information indicating the configuration, are configured to:
determine the information indicating the configuration based at least in part on the information associated with the one or more parameters.

30. A base station for wireless communication, comprising:
a memory; and
one or more processors operatively coupled to the memory, the memory and the one or more processors configured to:
receive, from a user equipment (UE), information associated with one or more parameters associated with the UE, wherein the one or more parameters indicate at least one of a UE type of the UE or a measured channel condition at the UE;
assign the UE to a paging sub-group based at least in part on the UE type or the measured channel condition at the UE, wherein the paging sub-group is associated with a configuration; and
transmit a paging early indication (PEI) signal based at least in part on the configuration of the paging sub-group.
